(19) United States
(12) Patent Application Publication
(10) Pub. No.: US 2025/0275550 A1
(43) Pub. Date: Sep. 4, 2025

(54) ICE CREAM FORMULATIONS AND METHODS OF MAKING AND DISTRIBUTING ICE CREAM

(71) Applicant: CVT Inc., Sierra Madre, CA (US)

(72) Inventors: Joe Nicchi, Sierra Madre, CA (US); Zbynek Mlynarik, Boise, ID (US); Amar Moon, Sierra Madre, CA (US)

(21) Appl. No.: 18/592,309

(22) Filed: Feb. 29, 2024

(51) Int. Cl. A23G 9/40; A23G 9/32; A23G 9/34

(52) U.S. Cl. CPC A23G 9/40; A23G 9/327; A23G 9/34

(57) ABSTRACT

A soft serve ice cream formulation is disclosed that is suitable for packaging in a pouch and distribution in a grocery store. The formulation includes whole milk ranging from 45% to 60%, heavy cream ranging from 20% to 30%, non-fat dry milk ranging from 2% to 5%, sweetener ranging from 15% to 20%, stabilizer ranging from 0.1% to 0.5% by weight of the total formulation, emulsifier ranging from 0.1% to 0.5%; and flavor ranging from 0.1% to 2% by weight of the total formulation.

### FIELD

The present disclosure relates to ice cream formulations and methods of making. In particular, this disclosure relates to soft serve ice cream and consumer packaged goods including the soft serve ice cream.

### BACKGROUND

The widespread availability of ice cream in supermarkets, specialty stores, and eating establishments makes it a simple and hassle-free dessert choice. Soft serve ice cream is a popular type of ice cream enjoyed by people of all ages worldwide. Yet currently, soft serve ice cream is typically only available from ice cream trucks or ice cream parlors. Currently, soft serve does not store well in the freezer for extended periods because it may become icy and lose its creamy texture. Comparatively, hard ice cream has a denser and richer mouthfeel due to a higher fat content achieved through a batch churning process that minimizes air incorporation. Hard ice cream is typically served at a colder temperature and can be stored in the freezer for more extended periods without significant texture changes.

There are a few distinctions between soft serve and hard ice cream, despite both being frozen desserts. Unlike traditional hard ice cream, soft serve has a smoother, creamier texture due, in part, to the incorporation of air during the freezing process. The texture and fat content generally set soft serve formulations apart from hard ice cream. While soft serve often contains more stabilizers and emulsifiers, regular ice cream relies on its higher fat content for a creamy texture. Preparing the soft serve also contributes to achieving the desired texture, consistency, and quality of soft serve ice cream.

Soft serve and hard ice cream are also typically served at different temperatures. Soft serve is typically served at a slightly warmer temperature than ice cream to achieve its characteristically silky, creamy, light, and airy feel. The texture of soft serve ice cream is often lighter and softer than that of conventional ice cream, which is held at lower temperatures to give it a harder texture. However, the consistency of soft serve may vary depending on the recipe, ingredients, and equipment used to produce it.

### SUMMARY

An aspect of the disclosure is directed to soft serve formulations that are stable in freezers in a consumer packaged good. The formulations of the disclosure gradually start melting after being removed from a freezer for a few minutes. With its simplicity, great taste, and easy-to-serve packaging, the disclosed soft serve is specially crafted for grocery store convenience as well as sporting events or at-home consumption. In some embodiments, the disclosed soft serve formulations may be in pouches. In some embodiments, the disclosed soft serve formulations in pouches may provide a no-mess alternative to existing soft serve formulations.

An aspect of the disclosure is directed to soft serve formulations with all natural ingredients. In some embodiments, a soft serve ice cream formulation with only seven ingredients is provided. A soft serve formulation that is “mom friendly” using only seven ingredients offers numerous advantages, including clean labeling, allergen-friendliness, enhanced flavors, improved texture, and streamlined production processes. The simplicity and transparency of the formulation contribute to a positive consumer experience. Additionally, while restricting to seven natural ingredient constrains the possible variables to achieve the desired texture, taste and melting characteristics, the disclosure provides formulations that still achieve some or all of the described characteristics while simply using seven ingredients.

An aspect of the disclosure is directed to soft serve formulations that melt slightly after removing from a freezer. Other soft serve formulations may use an artificial temperature-responsive ingredient designed to undergo a controlled phase transition, causing a moderate melting effect when the soft serve is removed from the freezer and exposed to ambient temperatures. In contrast, the disclosed formulations achieve the same result but by still using a limited number of natural ingredients, in part by the disclosed blend of emulsifiers, stabilizers and the methods used to process the soft serve (e.g. the air overrun used). Advantageously, the disclosed formulations may mitigate some of the irreversible effects seen when temperatures rise, such as ice crystal melt and air cell collapse.

In fact, after being in contact with warmer air for just a few minutes, existing formulations of soft serve can rapidly start to thaw and, even if refrozen, the soft serve may be subject to shrinkage, gritty ice crystals, and lactose crystals, all of which contribute to a sandy-mouthfeel. Accordingly, one aspect of the disclosure provides for formulations that melt slightly after removed from a freezer but at an appropriate rate, such as 5, 10, 15 or even 30 minutes at room temperature. A desirable rate for soft serve ice cream to melt strikes a balance between retaining the soft serve's creamy texture and maintaining a pleasant consistency. Ideally, the soft serve should melt at a slow and gradual rate, allowing consumers to savor the texture while preventing excessive liquid runoff. A slow melting rate ensures that the ice cream remains enjoyable for a more extended period, enhancing the overall sensory experience. Additionally, a slow melt rate helps to minimize messiness and drips, making it easier for consumers to enjoy their soft serve without worrying about quick melting leading to waste. However, it is useful when the melting process is not too slow, as the ice cream should still melt eventually to provide a smooth and palatable consistency for consumption.

An aspect of the disclosure is directed to methods of making soft serve formulations according to the disclosure. The disclosure introduces novel formulations that enhance the creaminess, stability, and shelf life of soft serve ice cream. Specific weight percentage ranges of dairy components, sweeteners, stabilizers, and emulsifiers are disclosed, each with a synergistic effect in achieving desired results. The disclosure provides freezing techniques and equipment configurations designed to achieve precise temperature control, leading to a superior and consistent soft serve texture. The disclosure also outlines streamlined production processes, reducing manufacturing times, and minimizing energy consumption. It introduces efficient mixing and dispensing mechanisms that enable higher production throughput while maintaining product integrity.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear. While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

FIG. 1 schematically illustrates a soft serve machine used to produce the ice cream. This FIGURE showcases the machine's components, such as the freezing chamber, dispensing mechanism, and control panel.

### DETAILED DESCRIPTION

All references cited herein are incorporated herein by reference in their entirety. If a term or phrase is used herein in a way that is contrary to or otherwise inconsistent with a definition set forth in the patents, applications, published applications and other publications that are herein incorporated by reference, the use herein prevails over the definition that is incorporated herein by reference.

The ingredients used in ice cream production play a role in determining its taste, texture, and overall quality. While recipes and formulations can vary, the following disclosure outlines the non-limiting examples of ingredients and the corresponding ranges found in soft serve ice cream. The various components may be turned relative to each other to achieve desirable properties of a final formulation. For example, the total amount of fat may be increased and the amount of an emulsifier may decrease in order to maintain a desired mouth feel while keeping the formulation stable in a freezer, and not cause ice crystals to form in the formulation.

### Formulations

An aspect of the disclosure is directed to formulations that are stable in freezers in a consumer packaged good. In some embodiments, the formulation is an ice cream formulation. In some embodiments, the formulation is a soft serve formulation. The following nonlimiting examples of ingredients may be used in the disclosed ranges to provide a soft serve formulation that is suitable for refrigeration and storage in a pouch: whole milk, heavy cream, non-fat dry milk or whole dry milk, one or more sweeteners, one or more stabilizers, one or more emulsifiers, and one or more flavoring agents, or a combination thereof. Some embodiments of the disclosure include formulations that use a limited number of ingredients.

### Dairy Components:

The primary dairy components in soft serve ice cream are milk and cream. Milk provides the base liquid, contributing to the overall volume and texture. Cream, with its higher fat content, adds richness and a creamy mouthfeel. The ratio of milk to cream can vary depending on the desired fat content of the ice cream. Generally, the milk-to-cream ratio falls within the range of 1:1 to 3:1.

Milk Content Range: The milk content in soft serve ice cream formulations may be varied to provide a smooth and creamy base. The milk component by weight may fall within the range of approximately 45% to approximately 60% by weight of the total formulation. This range provides a balanced dairy flavor while offering a suitable foundation for the other ingredients.

In some embodiments the milk content may range from approximately 45% to approximately 60% of the total formulation. In some embodiments the milk content may range from approximately 46% to approximately 49% of the total formulation. In some embodiments the milk content may range from approximately 49% to approximately 59% of the total formulation. In some embodiments the milk content may range from approximately 50% to approximately 58% of the total formulation. In some embodiments the milk content may be at least one of approximately 55%, 56%, 57%, 58% and 59% of the total formulation. In some embodiments, the milk content may be greater than 55% of the total formulation. In some embodiments, the milk content may be greater than 56% of the total formulation. In some embodiments, the milk formulation may be approximately 45%, 46%, 47%, 48%, 49%, 50%, 51%, 52%, 53%, 54%, 55%, 56%, 57%, 58%, 59%, 60%, or ranges including, between, and/or spanning the aforementioned values. In some embodiments, the milk includes an animal's milk. In some embodiments, the animal's milk is selected from, but not limited to, a cow, goat, sheep, or buffalo. In some embodiments, the milk includes whole milk. In some embodiments, the milk content may be a reduced fat whole milk product. In some embodiments, the milk includes 2% milk. In some embodiments, the milk includes 1% milk. In some embodiments, the milk includes skim milk. In some embodiments, the milk includes one or more milk sources, for example, one or more animals, plant sources, or blends of types of milks from the same source. In some embodiments, the milk includes almond milk. In some embodiments, the milk includes oat milk. In some embodiments, the milk includes a rice milk. In some embodiments, the milk includes a soy milk. In some embodiments, the milk includes a hemp milk. In some embodiments, the milk includes a cashew milk.

In some embodiments, the milk content may be adjusted based on the flavoring of the soft serve. In some embodiments, the milk content of a vanilla soft serve formulation may range from approximately 45% to approximately 60% by weight of the total formulation. In some embodiments, the milk content of a vanilla soft serve formulation may range from approximately 54% to 60%. In some embodiments, the milk content of a vanilla soft serve formulation of a vanilla soft serve formulation may range from approximately 55% to 59%. In some embodiments, the milk content of a vanilla soft serve formulation may be at least one of approximately 55%, 56%, and 57% of the total formulation. In some embodiments the milk content of a vanilla soft serve formulation may be at least one of approximately 55%, 56%, 57%, 58% and 59% of the total formulation. In some embodiments, the milk content of a vanilla soft serve formulation may be greater than 55% of the total formulation. In some embodiments, the milk content of a vanilla soft serve formulation may be greater than 56% of the total formulation. In some embodiments, the milk content of a vanilla soft serve formulation may be approximately 45%, 46%, 47%, 48%, 49%, 50%, 51%, 52%, 53%, 54%, 55%, 56%, 57%, 58%, 59%, 60%, or ranges including, between, and/or spanning the aforementioned values.

In some embodiments, the milk content of a chocolate soft serve formulation may range from approximately 45% to 60% of the total formulation. In some embodiments, the milk content of a chocolate soft serve formulation may range from approximately 50% to 60%. In some embodiments, the milk content of a chocolate soft serve formulation may range from approximately 52% to 58%. In some embodiments, the milk content of a chocolate soft serve formulation may range from approximately 53% to 57%. In some embodiments, the milk content of a chocolate soft serve formulation may be at least one of approximately 55%, 56%, and 57% of the total formulation. In some embodiments, the milk content of a vanilla soft serve formulation may be greater than 56% of the total formulation. In some embodiments, the milk content of a chocolate soft serve formulation may be approximately 45%, 46%, 47%, 48%, 49%, 50%, 51%, 52%, 53%, 54%, 55%, 56%, 57%, 58%, 59%, 60%, or ranges including, between, and/or spanning the aforementioned values.

Heavy Cream Content Range: Heavy cream can impart richness and contributes to the mouthfeel of soft serve ice cream. The weight percentage of heavy cream in the formulation may range from approximately 20% to approximately 30% by weight. Within this range, the soft serve may have desired creaminess without being excessively fatty.

In some embodiments, the heavy cream may range from approximately 20% to approximately 30% by weight of the total formulation. In some embodiments, the heavy cream may range from approximately 21% to approximately 29% by weight of the total formulation. In some embodiments, the heavy cream may range from approximately 22% to approximately 28% by weight of the total formulation. In some embodiments, the heavy cream may range from approximately 23% to approximately 27% of the total formulation. In some embodiments, the heavy cream may range from approximately 23% to approximately 25% ny weight of the total formulation. In some embodiments the heavy cream content may be at least one of approximately 23%, 24%, and 26% by weight of the total formulation. In some embodiments, a typical soft serve formulation may include heavy cream from approximately 25% to approximately 30% by weight of the total formulation, and the disclosed formulations may include heavy cream at less than 25%, less than 24.5%, less than 24%, and less than 23.5% by weight of the total formulation. In some embodiments, the heavy cream may range from approximately 20%, 21%, 22%, 23%, 24%, 25%, 26%, 27%, 28%, 29%, 30%, or ranges including, between, and/or spanning the aforementioned values. In some embodiments, the heavy cream includes an animal source. In some embodiments, the animal source is a cow. In some embodiments, the heavy cream is from a plant-based alternative. In some embodiments, the total fat of the formulation is conserved but the ratio of whole milk to heavy cream is changed.

Non-Fat Dry Milk Content Range: Non-fat dry milk may also serve as a milk solids source, influencing the texture and consistency of soft serve. The weight percentage of non-fat dry milk in the soft serve formulation may fall between approximately 2% to approximately 5%. This range typically serves to provide an appropriate milk solids content without overwhelming the soft serve with dry milk flavor.

In some embodiments, the non-fat dry milk may range from approximately 2.1% by weight to approximately 4.9% by weight of the total formulation. In some embodiments, the non-fat dry milk may range from approximately 2.1% to approximately 4.5% by weight of the total formulation. In some embodiments, the non-fat dry milk may range from approximately 2.1% to approximately 4.9% by weight of the total formulation. In some embodiments, the non-fat dry milk may range from approximately 2.1% to approximately 4.0% by weight of the total formulation. In some embodiments, the non-fat dry milk may range from approximately 2.1% to approximately 3.9% by weight of the total formulation. In some embodiments, the non-fat dry milk may range from approximately 2.3% to approximately 3.6% by weight of the total formulation. In some embodiments, the non-fat dry milk may range from approximately 2.5% to approximately 3.5% by weight of the total formulation. In some embodiments, the non-fat dry milk may range from approximately 2.6% to approximately 3.4% by weight of the total formulation. In some embodiments, the non-fat dry milk may range from approximately 2.7% to approximately 3.3% by weight of the total formulation. In some embodiments, the non-fat dry milk may range from approximately 2.8% to approximately 3.2% by weight of the total formulation. In some embodiments, the non-fat dry milk may range from approximately 2.9% by weight to approximately 3.1% by weight of the total formulation. In some embodiments, the non-fat dry milk may be at least one of approximately 2.90%, 2.95%, and 2.99% by weight of the total formulation. The non-fat dry milk for existing soft serve formulations may be typically provided in a range of approximately 3% by weight to approximately 5% by weight, but in some embodiment the soft serve formulations may include non-fat dry milk in the formulation at less than 3% by weight of the total formulation. In other embodiments, the non-fat dry milk may range from approximately 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, or ranges including, between, and/or spanning the aforementioned values. In some embodiments, the non-fat dry milk is instant non-fat dry milk. In some embodiments, the non-fat dry milk is agglomerated dry milk. In some embodiments, the non-fat dry milk is dry buttermilk. In some embodiments, the non-fat dry milk is dry whey. In some embodiments, the non-fat dry milk is dry goat milk. In some embodiments, the non-fat dry milk is lactose-free dry milk.

In some embodiments, the soft serve formulation includes whole dry milk. Powdered whole milk retains the fat content of its liquid counterpart, offering a richer flavor and textures. In some embodiments, the total fat of the formulation is conserved but the ratio of whole milk to heavy cream is changed based on the fat content of the whole dry milk. In other embodiments, the whole dry milk may range from approximately 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0% by weight, or ranges including, between, and/or spanning the aforementioned values.

### Sweeteners:

In some embodiments, the soft serve formulation includes one or more sweeteners. In some embodiments, the one or more sweetener is a natural sweetener, a sugar alcohol, or an artificial sweetener. In some embodiments, the natural sweetener may include, but is not limited to, sucrose, dextrose, fructose, liquid invert sugar, honey, maple syrup, corn syrup, agave nectar, molasses, stevia, coconut sugar, date sugar, or a combination thereof. In some embodiments, the sugar alcohols may include, but are not limited to, xylitol, erythritol, sorbitol, mannitol, or a combination thereof. In some embodiments, the artificial sugars may include, but is not limited to, high fructose corn syrup, aspartame, sucralose, saccharin, acesulfame potassium, aceotame, or a combination thereof. In some embodiments, the soft sere formulation includes one or more sugars, such as table sugar or sucrose. Sugar is the most common sweetener, and its quantity typically ranges from 12% to 20% of the total ice cream mixture. Soft serve ice cream formulations can incorporate various types of sweeteners to achieve the desired level of sweetness and taste.

In some embodiments, the soft serve formulation includes one or more sweetener from approximately 12%, 12.5%, 13%, 13.5%, 14%, 14.5%, 15%, 15.5%, 16%, 16.5%, 17%, 17.5%, 18%, 18.5%, 19%, 19.5%, 20%, by weight, or ranges including, between, and/or spanning the aforementioned values. In some embodiments, the soft serve formulation includes one or more sweeteners from approximately 15% to approximately 20% by weight. In some embodiments, the soft serve formulation includes one or more sweeteners from approximately 15% to approximately 16% by weight. In some embodiments, ice creams and soft serves according to the disclosure may include at least one of the sweeteners above. In some embodiments, ice creams and soft serves according to the disclosure may include only one of the sweeteners listed above. In some embodiments, a lower limit of sugar content may be set to ensure a satisfactory level of sweetness and mouthfeel. In some embodiments, the sugar content by weight ranges from approximately 12% to 14% of the total ice cream formulation. This range may provide a baseline level of sweetness and has not been observed to compromise the formulations' structural integrity. In some embodiments, a sugar content range is designed to offer a well-balanced and appealing soft serve ice cream. In some embodiments, the sugar content by weight ranges from approximately 14.5% to 16.5% by weight of the total formulation. In some embodiments with sugar content within this range, the soft serve exhibits a pleasant level of sweetness, an enhanced the flavor profile, and maintains an optimal texture during the freezing process. In some embodiments, an upper limit of sugar content may be defined to prevent excessive sweetness and maintain proper freezing properties. A maximum sugar content may include multiple types of sugars and sweeteners. In some embodiments, a maximum sugar content by weight ranges from approximately 17% to 20% by weight of the total formulation. Adherence to this range ensures that the soft serve does not become overly sweet or difficult to handle during dispensing and storage.

### Stabilizers:

In some embodiments, the soft serve formulation may include one or more stabilizers. In some embodiments, one or more stabilizers include plant-based stabilizers, seaweed-derived stabilizers, animal-derived stabilizers, synthetic or semi-synthetic stabilizers, or a combination thereof. In some embodiments, the one or more stabilizers may include, but is not limited to, guar gum, xanthan gum, locust bean gum (Carob Gum), vegetable fiber, tara gum, pectin, natural polysaccharides, cellulose gum, carboxymethyl cellulose and cellulose derivatives, alginate, tara gum, carrageenan, agar-agar, gelatin, glycerol monostearate, polysorbates, for example polysorbate 80, microcrystalline cellulose, lecithin, or a combination thereof. In some embodiments, the one or more stabilizers may provide a thickening effect. In some embodiments, the thickening effect may also have a relationship with the rated rotation speed of the stirring blade of a soft ice cream maker. In other embodiments, the plant-based stabilizers, seaweed-derived stabilizers, and animal-derived stabilizers may be substituted for alternatives that provide similar physical properties while not being constrained to natural ingredients. In some embodiments, the one or more stabilizers improves texture and stability by inhibiting ice crystal growth. For example, locust bean gum: a plant-based gum that enhances creaminess and prevents phase separation; carrageenan: extracted from seaweed, this stabilizer contributes to a smooth texture and prevents the formation of large ice crystals; xanthan gum: a microbial gum that imparts viscosity and reduces the occurrence of ice crystal agglomeration; cellulose derivatives: these compounds enhance creaminess and stabilize the ice cream structure; sodium alginate: derived from brown algae, this stabilizer forms a gel-like structure that enhances creaminess and prevents ice crystal growth; carboxymethyl cellulose (cmc): a cellulose derivative that improves texture and consistency by binding water and fat molecules; hydroxypropyl methylcellulose (hpmc): this stabilizer helps in preventing air incorporation during freezing and maintains a smooth texture; and gellan gum: a polysaccharide that provides excellent stabilizing properties and controls the flow behavior of soft serve.

In some embodiments, the soft serve formulation may include one more stabilizers from approximately 0.1%, 0.15%, 0.2%, 0.25%, 0.3%, 0.35%, 0.4%, 0.5% by weight, or ranges including, between, and/or spanning the aforementioned values. In some embodiments, soft serve formulation includes one or more stabilizers from approximately 0.3% to approximately 0.4% by weight. In some embodiments, the one or more stabilizers includes a blend of guard gum, vegetable fiber, and tara gum.

### Emulsifiers:

In some embodiments, the soft serve formulation includes one or more emulsifiers. In some embodiments, the one or more emulsifiers include a natural emulsifier, a synthetic emulsifier, or a semi-synthetic emulsifier. In some embodiments, the one or more emulsifiers include, but are not limited to, lecithin, mono- and diglycerides of fatty acids, polysorbates, for example, polysorbate 80, sorbitan monostearate, glycerol monostearate, sodium stearoyl-2-lactylate, propylene glycol monostearate, sucrose esters of fatty acids (E473), distilled monoglycerides, polyglycerol esters of fatty acids (E475), sodium stearoyl lactylate (SSL), calcium stearoyl lactylate (CSL), polyoxyethylene (20) sorbitan monostearate (Tween 60), polyoxyethylene (20) sorbitan tristearate (Tween 65), polyoxyethylene (20) sorbitan monolaurate (Tween 20), and diacetyl tartaric acid esters of monoglycerides (DATEM). Each emulsifier may offer functionalities and benefits, contributing to the overall stability, mouthfeel, and quality of soft serve ice cream products, providing manufacturers with a diverse range of options to achieve the desired texture. Lecithin: Derived from soybean or egg yolk, it promotes the homogenization of fats and liquids, resulting in a smooth and creamy texture; Mono- and Diglycerides: These emulsifiers improve air incorporation, leading to a softer and lighter ice cream; Polysorbates: Synthetic emulsifiers that improve the dispersion of fats, contributing to a more stable and consistent product; Glyceryl Monostearate: An emulsifier that enhances the dispersion of fat and water, resulting in a smoother and creamier texture; Polysorbate 80: A synthetic emulsifier that improves the stability of the emulsion, preventing phase separation and providing a consistent product; Sorbitan Monostearate: In some embodiments, one or more emulsifiers may help homogenize fat and water components, ensuring a well-incorporated mixture.

In some embodiments, the soft serve formulation may include one more emulsifiers from approximately 0.1%, 0.15%, 0.2%, 0.25%, 0.3%, 0.35%, 0.4%, 0.5% by weight, or ranges including, between, and/or spanning the aforementioned values. In some embodiments, the weight percentages of emulsifiers used can vary depending on the desired characteristics of the soft serve. Commonly employed ranges for emulsifiers may include 0.1% to 0.5%, 0.3% to 0.7%, and 0.5% to 1.0% of the total formulation by weight. Lower percentages, such as 0.1% to 0.5%, are typically suitable for achieving a light and delicate texture, for fruit-flavored or dairy-free soft serves. Meanwhile, mid-range percentages like 0.3% to 0.7% provide a balance between creaminess and smoothness, well-suited for classic flavors. Higher ranges, such as 0.5% to 1.0%, offer increased stability for some soft serve variants. In one such embodiment, sunflower Lecithin may be included as an emulsifier at approximately 0.05% weight percentage of the total formulation. In other embodiments, the natural ingredients may be substituted for alternatives that provide similar physical properties while not being constrained to natural ingredients. The range of less than 1% by weight of emulsifier in soft serve ice cream formulations offers a distinct advantage over the typical ranges of weight percentages. Emulsifiers play a role in stabilizing the fat and water components, ensuring a smooth and creamy texture. By using emulsifiers in lower percentages, such as less than 1%, soft serve manufacturers can achieve a delicate and light texture that enhances the overall eating experience. This lower emulsifier content allows the natural flavors of the ingredients to shine through, creating a more authentic and enjoyable taste profile. Additionally, the reduced emulsifier presence contributes to a cleaner ingredient label, aligning with the preferences of health-conscious consumers who seek products with fewer additives.

The disclosure includes detailed descriptions of the methods for incorporating the stabilizers and emulsifiers into ice cream formulations. The appropriate concentrations, mixing procedures, and temperature requirements are disclosed to achieve desired results. The mixing procedure involves dispersing the stabilizers and emulsifiers evenly throughout the ice cream mix. This is usually achieved by first mixing the ingredients with a small amount of sugar from the recipe to prevent lumping and then adding this mixture to the liquid ingredients under high shear conditions to ensure complete dispersion. The mix may then be pasteurized, which involves heating to about 65-85° C. (149-185° F.) for about 10 to 30 minutes, depending on the pasteurization method used. This heat treatment not only ensures the safety of the product by destroying pathogenic bacteria but also may activate certain ingredients, allowing them to fully hydrate and swell, thereby improving the mix's viscosity and stabilizing the emulsion. After pasteurization, the mix is homogenized at a pressure of 140-200 bar (2000-2900 psi) to further reduce the size of fat globules, enhancing the action of emulsifiers in stabilizing the fat emulsion. Finally, the mix is cooled rapidly to 4° C. (39° F.) or below to halt microbial growth and aged for 4 to 8 hours or overnight to allow the stabilizers to fully hydrate and the fat to crystallize, improving the whipping properties and body of the final product.

In some embodiments, the amount or ratio of stabilizers and emulsifiers improves the sensory attributes of the soft serve formulation, such as creaminess, mouthfeel, and flavor release. In some embodiments, the amount or ratio of stabilizers and emulsifiers extends shelf-life of the soft serve formulation, maintain the desired texture during storage of the soft serve formulation, and enhance the overall consumer experience of the soft serve formulation. In some embodiments, the amount or ratio of stabilizers and emulsifiers reduces ice crystal formation of the soft serve formulation, enhance mouthfeel of the soft serve formulation, and maintains the desired texture during dispensing and storage of the soft serve formulation. In some embodiments, the amount or ratio of the stabilizers and emulsifiers and maintain the desired texture during dispensing and storage of the soft serve formulation. To improve texture and prevent ice crystal formation, stabilizers and emulsifiers are often included in soft serve formulations. Common stabilizers include guar gum, locust bean gum, carrageenan, and xanthan gum. Emulsifiers like lecithin help to blend the fat and water components of the ice cream, contributing to a smooth and creamy texture. These ingredients are usually added in small amounts, each ranging from 0.1% to 0.5% each of the ice cream mixture.

### Flavorings:

In some embodiments, the soft serve formulation includes one or more flavoring agents. In some embodiments, the one or more flavoring agents may include a natural flavoring agent, an artificial flavoring agent, compound flavors, an exotic flavor, a trendy flavor, an alcohol-based flavor, or a combination thereof. In some embodiments, the one or more flavoring agents may include, but are not limited to, vanilla, fruit purees and concentrates, coca powder and chocolate, coconut, coffee, nuts, spices, herbs, honey, caramel, butterscotch, bubblegum, cookies and cream, candy-based flavors, matcha, saffron, charcoal, salted caramel, rum, whiskey, wine, strawberry, raspberry, mango, almonds, pecans, walnuts, pistachios, cinnamon, nutmeg, clove, mint, basil, lavender, and combinations thereof. Flavorings can impart distinct tastes to ice cream. Vanilla extract is the classic and widely used flavor, but other extracts, such as almond, mint, or coconut, are also common. Cocoa powder or melted chocolate is employed to create chocolate-flavored ice cream. Classic ice cream flavors may evoke a sense of nostalgia and remain beloved by many. Vanilla is a timeless favorite and serves as a versatile base for a number of other toppings and mix-ins. Similarly, chocolate, with its indulgent cocoa flavor, is another common favorite. Strawberry offers a refreshing and fruity option, and may provide a lighter and more natural taste. Ice cream makers often use a variety of fruits to create refreshing and vibrant flavors. Fruity sorbets, made without dairy, showcase the essence of fruits like raspberry, mango, lemon, and passion fruit, delivering a burst of natural sweetness and tanginess. For a delightful textural contrast and nutty richness, ice cream enthusiasts can savor flavors like pistachio, almond, hazelnut, and peanut butter. These flavors add a distinct depth and complexity, combining the creaminess of ice cream with the crunch or smoothness of nuts. Cookie and Candy-Inspired flavoring like cookies and cream, or cookie dough may also offer a desirable combination of ice cream and cookie flavors. Similarly, candy-inspired flavors like mint chocolate chip, butterfinger, or caramel swirl may be employed. Other flavors may include Coffee and Tea Infusions. Coffee enthusiasts can enjoy the flavor of coffee ice cream, often paired with chocolate or caramel accents. Additionally, tea-infused ice creams, such as Earl Grey or green tea, offer a twist and a more aromatic experience. Some ice cream flavors may also be crafted to celebrate specific seasons or holidays. Pumpkin spice, apple pie, peppermint, and eggnog flavors bring a festive touch during the fall and winter months, while watermelon, lemonade, or coconut may offer a respite during the summer.

In some embodiments, the soft serve formulation may include one more flavoring agents from approximately 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0% by weight, or ranges including, between, and/or spanning the aforementioned values.

### Viscosity

In some embodiments, the viscosity of output of an ice cream may be adjusted to produce a desired outcome. The viscosity of soft serve ice cream is typically measured in centipoise (cP) and can range widely depending on the ingredients, temperature, and air incorporation. Typical values might vary from about 1500 cP to about 25000 cP (or more depending on the specific formulation and the temperature at which the measurement is taken). In some embodiments, the viscosity may be measured at about −5 degrees Celsius.

In some embodiments, the viscosity of the soft serve formulation may range from any of 1500 cP to about 25000 cP, 1600 cP to about 24000 cP, 1700 cP to about 23000 cP, 1800 cP to about 22000 cP, 1900 cP to about 21000 cP, 2000 cP to about 20000 cP, 2100 cP to about 19000 cP, 2200 cP to about 18000 cP, incrementally increasing and decreasing to 2300 cP to about 17000 cP, 2400 cP to about 16000 cP, and continues in this manner through 2500 cP to about 15000 cP, 2600 cP to about 14000 cP, 2700 cP to about 13000 cP, 2800 cP to about 12000 cP, 2900 cP to about 11000 cP, 3000 cP to about 10000 cP, further to 3100 cP to about 9000 cP, 3200 cP to about 8000 cP, 3300 cP to about 7000 cP, 3400 cP to about 6000 cP, 3500 cP to about 5000 cP, 3600 cP to about 4000 cP, and at 3700 cP to about 3000 cP.

In some embodiments, the viscosity of the soft serve formulation may be quantified by a displayed number on the machine preparing or dispensing the soft serve. This number allows for adjusting the viscosity output of the ice cream during the extraction process and may represent the Electrical Amps the motor consumes in order to determine the thickness of (viscosity) of the product at the time the soft serve is being extracted. The number displayed may be different depending on the size shape and surface area of the stirrer, however, the number may be consistent with subsequent runs on a single model of machines. For example, the Explorer 1500 from Technogel may display a viscosity reading from about 12 to about 20. In some embodiments, the viscosity reading may be from about 14 to 18. In some embodiments, the viscosity reading may be from about 16 to 18. In some embodiments, the viscosity may be measured at about −5 degrees Celsius.

### Ice Crystal Size

Quantifying ice crystals in soft serve ice cream may involve examining the size, distribution, and quantity of ice crystals within the product. In some embodiments, a quantifying process may employ a combination of microscopy techniques, such as scanning electron microscopy (SEM) or cryo-scanning electron microscopy (cryo-SEM), and image analysis software. These methods enable scientists and food technologists to visually inspect and measure the ice crystals formed during the freezing process.

In addition to microscopy, differential scanning calorimetry (DSC) is another technique used to quantify the thermal properties of ice cream, including ice crystallization and melting behaviors. DSC can provide indirect information about the size distribution of ice crystals based on the amount of energy required to melt them. Smaller ice crystals, which are preferred for a smoother texture, require less energy to melt compared to larger crystals.

Accordingly, in some embodiments, ice crystals in a frozen ice cream product before and after being exposed to room temperature for at least 5 minutes (but also up to 10, 15, or 20 minutes) will range between 10 to 80 micrometers. In some embodiments, the ice crystals are between 10 and 50 micrometers. In some embodiments, the ice crystals are between 10 and 30 micrometers. In some embodiments, the ice crystals are less than 50 micrometers. In some embodiments, the ice crystals are less than 50 micrometers. In some embodiments, the ice crystals may be quantified by the average size. In some embodiments, the ice crystals may be quantified by the median size.

### Freezing/Melting Properties

An aspect of the disclosure is directed to a soft serve formulation that retains the soft serve consistency during freezing. In some embodiments, the soft serve formulation may retain the soft serve consistency after being frozen for an extended period of time. In some embodiments, the soft serve formulation may retain the soft serve consistency after shipping. In some embodiments, the soft serve formulation may retain the soft serve consistency after being exposed to room temperature. In some embodiments, the soft serve formulation may remain frozen under the following conditions: commercial freezer truck temperatures ranging from about −18 to −20 degrees Celsius, commercial ice cream freezer trucks temperatures ranging from about −26 to −28 degrees Celsius, commercial freezers in warehouses utilized by commercial facilities, retail store freezers that are presently utilized to store and as point of sale freezers for bulk frozen desserts where this temperature range being generally from about −25 to −30 degrees Celsius, home deep freezers systems being in the range of about −15 to −18 degrees Celsius where the home freezer associated with a fridge where this temperature range being generally from about −6 to −10 degrees Celsius.

In some embodiments, controlling the melting behavior of soft serve ice formulation can be achieved by, for example, adjusting the overrun during the soft serve production process. Overrun refers to the amount of air incorporated into the ice cream during the freezing and whipping process. By manipulating the overrun, manufacturers can influence the soft serve's texture, consistency, and resistance to melting. In some embodiments, the amount of overrun can be used to impact the melting behavior of soft serve. When the overrun is high (Increased Air Content), a larger volume of air is incorporated into the soft serve, resulting in a lighter and fluffier texture. Without being bound by theory, the air acts as an insulator, creating air pockets within the ice cream structure. This increased air content reduces the amount of actual ice cream present, leading to a lower overall heat capacity, but in some instances a lower heat conductance. As a result, soft serve with high overrun begins to melt more quickly since there is less mass to retain the cold temperature, but the interior of the soft serve may melt at a different rate because heat may diffuse into the cone slower due to a lower heat conductance. Conversely, when the overrun is low (Decreased Relative Air Content), the soft serve contains less air and more ice cream. This results in a denser and creamier texture with a higher heat capacity. Soft serve with low overrun tends to melt more slowly as there is more mass to retain the cold temperature. Additionally, a higher heat conductance may result in the entirety of the soft serve melting around the same time.

In some embodiments, the soft serve formulation may retain the consistency of soft serve ice cream by including a higher fat content. Higher Fat Content may also change the melting rate of soft serve. Soft serve with a higher fat content, achieved by using more heavy cream or other high-fat dairy ingredients, tends to have a creamier and richer texture. The presence of a higher fat content creates a more stable emulsion within the ice cream, leading to a smoother mouthfeel and a slower rate of melting. The fat acts as a barrier, inhibiting the movement of water molecules and preventing ice crystal formation, resulting in a more solid and slower-melting soft serve. Soft serve with a lower fat content, achieved by reducing the amount of heavy cream or other high-fat dairy components, tends to have a lighter and less creamy texture. A lower fat content may lead to a quicker rate of melting, as soft serve ice cream with lower fat content might have a more ice-like texture and be prone to faster melting.

In some embodiments, the soft serve formulation may retain the consistency of soft serve ice cream by including one or more stabilizers and one or more emulsifiers. Stabilizers may also affect the melting rate of the soft serve, and may help maintain the structure and stability of ice cream by preventing the formation of large ice crystals. By increasing the amount of stabilizer in the formulation, ice cream manufacturers can enhance the soft serve's resistance to melting. The stabilizer creates a more structured network within the ice cream, improving its ability to retain its shape and consistency even in warmer temperatures. Similarly, by controlling the emulsifier content, manufacturers can influence the distribution of fat, affecting the soft serve's mouthfeel and melting properties. Emulsifiers can create a more uniform fat matrix, leading to a creamier texture and slower rate of melting.

In some aspects, the techniques described herein relate to an ice cream formulation, including: whole milk ranging from 45% to 60% by weight of the total formulation; heavy cream ranging from 20% to 30% by weight of the total formulation; non-fat dry milk ranging from 2% to 5% by weight of the total formulation; sweetener ranging from 15% to 20% by weight of the total formulation; stabilizer ranging from 0.1% to 0.5% by weight of the total formulation; emulsifier ranging from 0.1% to 0.5% by weight of the total formulation; and flavor ranging from 0.1% to 2% by weight of the total formulation.

Some embodiments relate to an ice cream formulation, wherein the formulation may be a soft serve formulation, and the soft serve formulation has an air overrun of 20% to 100%. Some embodiments relate to an ice cream formulation, wherein the soft serve formulation has a viscosity between 1600-1800 cP at about −5° C.

Some embodiments relate to an ice cream formulation, wherein the soft serve formulation consists essentially of whole milk ranging from 45% to 60% by weight of the total formulation; heavy cream ranging from 20% to 30% by weight of the total formulation; non-fat dry milk ranging from 2% to 5% by weight of the total formulation; sweetener ranging from 15% to 20% by weight of the total formulation, stabilizer ranging from 0.1% to 0.5% by weight of the total formulation; emulsifier ranging from 0.1% to 0.5% by weight of the total formulation; and flavor ranging from 0.1% to 2% by weight of the total formulation.

Some embodiments relate to an ice cream formulation, wherein the formulation may be solid at 0 degrees Celsius and begin to partially melt after 5 minutes at 25 degrees Celsius. Some embodiments relate to an ice cream formulation, wherein the formulation may be packaged in a pouch. Some embodiments relate to an ice cream formulation, wherein the formulation may be solid at 0 degrees Celsius and begins to have liquid flow after 5 minutes at 25 degrees Celsius.

Some embodiments relate to an ice cream formulation, wherein the pouch may be a plastic pouch with a screw on a distal end of the plastic pouch, and the thickness of the pouch may be between 50 μm and 150 μm. Some embodiments relate to an ice cream formulation, wherein the formulation remains frozen for at least 30 minutes while in contact with an ice bath.

Some embodiments relate to an ice cream formulation, wherein the whole milk ranges from 54% to 57% by weight. Some embodiments relate to an ice cream formulation, wherein the heavy cream ranges from 22% to 24% by weight. Some embodiments relate to an ice cream formulation, wherein the sweetener ranges from 15% to 16% by weight. Some embodiments relate to an ice cream formulation, wherein non-fat dry milk ranges from 2% to 4% by weight. Some embodiments relate to an ice cream formulation, wherein the stabilizer ranges from 0.3% to 0.4% by weight. Some embodiments relate to an ice cream formulation, wherein the stabilizer may be a blend of Guar Gum, Vegetable Fiber, Tara Gum. Some embodiments relate to an ice cream formulation, wherein the emulsifier ranges from 0.02% to 0.07% by weight. Some embodiments relate to an ice cream formulation, wherein the emulsifier may be Sunflower Lecithin.

Some embodiments relate to a method 1, the method including: mixing one or more ingredients to create a mixture, wherein the one or more ingredients are selected from whole milk, heavy cream, non-fat dry milk, sweetener, stabilizer, emulsifier and flavor; emulsifying the mixture; pasteurizing the mixture; homogenizing the mixture; aging the mixture; freezing the mixture; and extracting the mixture.

Some embodiments relate to a method, wherein pasteurizing the mixture occurs at 73 degrees Celsius or above. Some embodiments relate to a method, wherein pasteurizing occurs for a minimum of 30 minutes.

In some embodiments, a pasteurized mixture may be cooled to between 4 degrees Celsius and 5 degrees Celsius.

In some embodiments, a pasteurized mixture may be aged and maintained between 4 degrees Celsius and 5 degrees Celsius.

In some embodiments, an aged mixture may be aged for at least 4 hours. In some embodiments, a frozen mixture may be extracted at a temperature between −7 degrees Celsius and −9 degrees Celsius. In some embodiments, the extracted mixture may be stored at an internal temperature between −20 degrees Celsius and −25 degrees Celsius. In some embodiments, the extracted mixture has a viscosity between 15 to 20 at about 5° C. In some embodiments, the extracted mixture has a viscosity between 16 to 18 at about 5° C. In some embodiments, the extracted mixture has a viscosity between 15 to 20 at about −5° C. In some embodiments, the extracted mixture has a viscosity between 16 to 18 at about −5° C. In some embodiments, the units of the viscosity may refer to the units on a Explorer 1500 from Technogel.

In some embodiments, the formulation may be a soft serve ice cream, and the soft serve ice cream has an air overrun of 20% to 100%. In some embodiments, the formulation may be a soft serve ice cream, and the soft serve ice cream has an average size of ice crystals that may be smaller than 50 micrometers, as measured by microscopy or differential scanning calorimetry. In some embodiments, the formulation may be a soft serve ice cream, and the soft serve ice cream has an average size of ice crystals that may be smaller than 30 micrometers.

In some embodiments, the formulation may be a soft serve ice cream, and the soft serve ice cream may be resilient to melting. In some embodiments, the formulation may be a soft serve ice cream, and the soft serve ice cream may be solid at 0 degrees Celsius and begins to have liquid flow after 5 minutes at 25 degrees Celsius. In some embodiments, the mixture may be stirred at a stir speed between 100 and 1000 RPM. In some embodiments, the mixture may be stirred at a stir speed between 100 and 1000 RPM.

### System

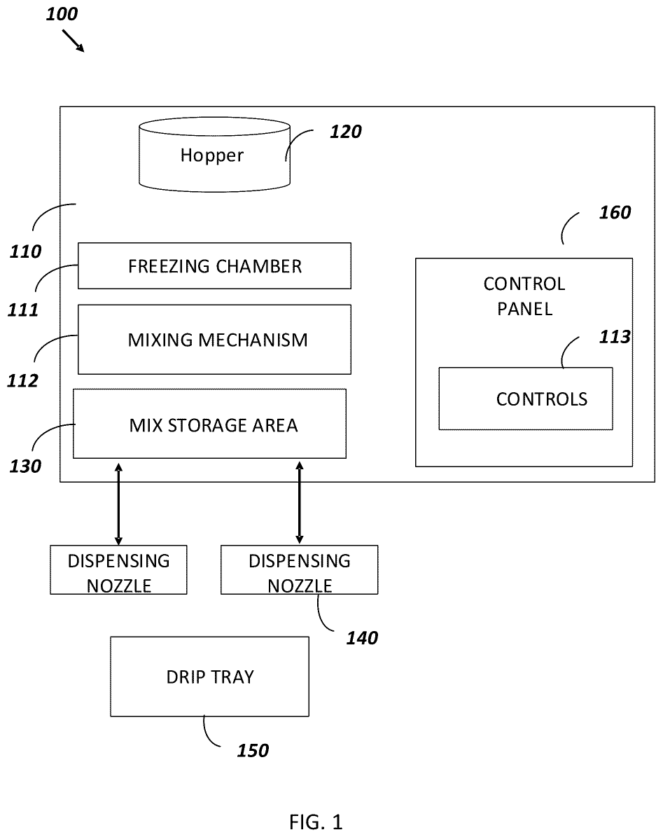

FIG. 1 depicts a schematic representation of a soft serve dispensing system 100, showcasing various components involved in serving or packaging soft serve ice cream. The system is designed to efficiently and hygienically dispense a creamy frozen dessert to customers at various manufacturing settings, such as an industrial kitchens, ice cream parlors, food trucks, and amusement parks. The soft serve dispensing system includes the following elements.

Positioned at the center of the FIGURE, the soft serve machine 110 is a central component of the dispensing system. Soft Serve Machine 110 includes a freezing chamber 111, a mixing mechanism 112, and controls 113 for adjusting the consistency and texture of the soft serve. The machine is capable of handling a continuous flow or batch processing of soft serve ice cream.

In certain embodiments, the hopper 120 stores the soft serve ice cream mix before freezing, and may be located on top of the soft serve machine. In other embodiments, such as continuous flow production, the hopper may be connected to a source for introducing additional soft serve premix. The mix storage area 130 is designed to maintain the mix at the ideal temperature to preserve its quality and consistency. The mix inside the mix storage area will be brought and maintained at a freezing temperature with alternatively a fast or slow cooling rate.

Multiple dispensing nozzles 140 may be situated at the bottom front of the soft serve machine 110. These nozzles are responsible for releasing the soft serve ice cream into serving cups, cones, pouches, or other containers with precision and accuracy. In some embodiments, more or fewer (as few as a single spigot) are provided for dispensing frozen food product. For example, frozen food product dispensing machine may include three freezer barrels and six spigots for providing six different types of frozen food product (e.g., vanilla, chocolate, strawberry, vanilla-chocolate swirl, vanilla-strawberry swirl, and chocolate-strawberry swirl). Located below the dispensing nozzles 140, an optional drip tray 150 may help ensure a clean serving area by capturing any excess drips that may occur during the dispensing process.

Positioned on the side of the soft serve machine, a control panel 160 provides operators with intuitive controls to adjust various parameters, such as product consistency, temperature, and dispensing speed. The control panel may be preprogrammed to maintain one set or parameters or may be adjusted throughout the soft serve production process.

Processing electronics may control a valve, spigot, or other appropriate actuator to cause the soft serve machine 110 to dispense the desired soft serve. The amount of soft serve dispensed can be detected based on the amount of time the product is being dispensed (e.g., time during which the valve is open), resistance to the actuator, detected by a flow sensor, detected based on the weight of the dispensed food product, or various combinations thereof.

### Air (Overrun):

During the freezing process, air is incorporated into the ice cream, known as overrun. The percentage of overrun indicates the volume increase of the ice cream due to the incorporation of air. A higher percentage of overrun results in lighter, fluffier ice cream. The typical overrun ranges from 20% to 100%, with some hard ice creams having lower overrun values to achieve a denser texture. While these ranges are common, the ranges can vary depending on a manufacturer's recipe, the type of ice cream (e.g., gelato, sorbet, and different flavors of soft serve), and regional preferences. While variations in ingredients and their ratios can result in a wide range of ice cream types, the disclosed formulations provide multiple examples within the disclosed ranges that possess suitable characteristics for retail of the soft serve in a pouch according to this disclosure.

### Process:

The process of making ice cream involves several steps. The following disclosure provides a non-limiting example for producing recipes and variations of the disclosed formulations. In some embodiments, a first step in making a soft serve formulation is to prepare a base, which includes milk, cream, sugar, and flavorings according to the disclosure. In some embodiments, the milk and cream are heated in a large container to a specific temperature, allowing the sugar to dissolve completely. In some embodiments, the base may be cooled again before adding additional ingredients like egg yolks for a custard-based ice cream or stabilizers and emulsifiers that may enhance texture and prevent ice crystal formation.

Once the base is prepared, the base may be flavored to create the desired taste. Common flavors include vanilla, chocolate, strawberry, and the other flavors disclosed here. Flavorings can be added to a warm base, infusing it with the chosen taste. For some variations, fruit purees, nuts, or other mix-ins may be added at this stage or optionally at any other stage consistent with this disclosure.

In some embodiments, preparation of the soft serve may include the step of pasteurization. In some embodiments, pasteurization may be optionally skipped if, for example, the ingredients are already pasteurized. If flavored, the flavored base may be heated again, but this time at a higher temperature to kill any harmful bacteria, ensuring the safety of the ice cream. Without being bound to a theory of operation the pasteurization process may also aid in blending the flavors evenly and enhancing the smoothness of the final product. After pasteurization, the ice cream soft serve base may be cooled down quickly to prevent any potential bacterial growth. In some embodiments, this soft serve base is then aged or “ripened” for a certain period to allow the flavors to meld and mature, resulting in a more robust and well-rounded taste.

In some embodiments, the optional aging process may be followed by the actual freezing of the ice cream. In some embodiments, the base may be stored in a liquid state for a period of time for later freezing. In some embodiments, a pasteurized Mix may be cooled to 4° C. (39° F.), and then being kept in an aging stage between 4-5° C. (39-41° F.). In some embodiments, a dispending machine may quickly or slowly freeze a liquid base to create soft serve. In some embodiments, the ice cream mixture is frozen in an ice cream freezer at a temperature of about-10° C. to −7° C. to provide ice cream. In some embodiments, the ice cream mixture is frozen at a temperature of about −20° C. to 0° C. In some embodiments, the ice cream mixture is frozen at a temperature of about −10° C. to −5° C.

In some embodiments, the ice cream mixture is frozen at a temperature of about −15° C. to 0° C., and then the soft serve may be dispensed at a higher or lower temperature. In some embodiments, the ice cream mixture is frozen at a temperature of about −10° C. to −5° C., and then the soft serve may be dispensed at a higher or lower temperature.

In some embodiments, the soft serve ice cream may be introduced into a shaping machine, or an extruder to be formed into a desired shape. In some embodiments, the mixture may be poured into an ice cream machine, where the mixture may be churned continuously. During this churning process, air may be incorporated into the ice cream, giving the soft serve a light and fluffy texture. Without being bound to a theory of operation, this continuous churning also helps prevent the formation of large ice crystals, further enhancing the smoothness of the final product.

As the soft serve reaches its frozen state, the soft serve may be transferred to containers, and any additional mix-ins, such as chocolate chips or cookie dough, may be folded in to add texture and extra bursts of flavor. Finally, the ice cream may be further hardened by placing it in a deep freezer to achieve a desired consistency. Once fully frozen, the soft serve may be packaged, and distributed.

In some embodiments, an ice cream may be prepared according to the following steps. Beginning with measuring, precise quantities of ingredients may be added to the mix to ensure consistency and quality in the final ice cream product. After measuring, the mixture undergoes emulsification, where emulsifying ingredients may be added to blend the fat and water components into a stable emulsion. The process may include pasteurization, where the mix may be heated to 73° C. (165° F.) for at least 30 minutes to reduce the risk of pathogenic microorganisms. Emulsification preferably occurs before pasteurization; however, in some embodiments, pasteurization may occur before or after any of the following method steps prior to freezing the mixture.

In some embodiments, following pasteurization, the product may pass through a homogenizer and heat exchanger before being transferred into aging tanks. The mix may then be cooled in the aging tanks to a temperature between 0° C. and 10° C., between 2° C. and 8° C., and/or between 4° C. and 5° C. (39° F. and 41° F.). The tanks may be programmed to automatically maintain the mix within a temperature range. The process may proceed with the mix being extracted and/or dispensed from a freezer with an internal temperature between −15° C. and −5° C., between −12° C. and −5° C., and/or between −7° C. and −9° C. (19° F.-16° F.). The consistency and texture of the ice cream at this stage may serve as indicators of the process's effectiveness. For example, the process has been observed to be reproducible and produce consistent viscosity unless one of the preceding steps has not been followed or there is an issue with one of the ingredients. For storage, a dispensed product may be kept at a temperature of −26° C. (−15° F.), with the ice cream itself measuring between −20° C. and −25° C. (−4° F. to −13° F.).

In some embodiments, the ice cream and/or soft serve may be produced such that it has a viscosity in a range between 16,000 cP to 18,000 cP at approximately 5° C. Note that there may be some variation in measured viscosity based on specific machinery used. Accordingly, in some embodiments, a product according to the disclosure may be produced such that it has a viscosity in a range between 14,000 cP to 20,000 cP at approximately −5° C. Accordingly, in some embodiments, a product according to the disclosure may be produced such that it has a viscosity in a range between 14,000 cP to 20,000 cP when at a temperature range from −7 to −3° C.

In some embodiments, dispensing soft serve ice cream into a pouch may involve a specialized process to ensure efficient and hygienic packaging as described below. Before dispensing, a soft serve ice cream may be freshly made using a soft serve machine. The ice cream mix may be frozen and aerated in the machine, resulting in the desired creamy and airy texture of soft serve. Sequentially or simultaneously, pouches designed for soft serve ice cream packaging may be prepared. In some embodiments these pouches are made of food-grade materials, ensuring they are safe for storing and preserving the ice cream. For example, the pouch may made by any of the nonlimiting examples of Polyethylene (PE), Polypropylene (PP), Polyethylene Terephthalate (PET), Polylactic Acid (PLA) and Polystyrene (PS).

In some embodiments, once the soft serve ice cream is prepared, a pouch may be positioned under a dispensing nozzle of a soft serve machine, and fill a deflated or inflated pouch to a desired volume. A machine operator or an automated processor may control the dispensing process, directing the flow of soft serve ice cream into the pouch. After filling the pouch to the desired volume, the pouch may be sealed to prevent any leakage or contamination. The sealing process may involve heat-sealing or any other suitable machinery designed for pouch packaging.

In some embodiments, quality control checks are performed throughout the manufacturing and dispensing process to ensure that the soft serve ice cream meets standards for taste, texture, and consistency. Any pouches, batches or portions of the soft serve that are found to be defective or outside the specified quality parameters are removed from the production line. In some embodiments, once the pouches are filled, sealed, labeled, and quality-checked, the filled pouches may be collected for transportation and storage. In some embodiments, a secondary packaging ensures that the soft serve ice cream remains in a desired condition until it reaches the end consumers. In some embodiments, the packaged soft serve ice cream pouches are then distributed to retail locations using cold chain transportation until the pouches arrive at the intended destination. Once available to consumers, the consumers can purchase the soft serve for immediate consumption or storage in their freezers.

As described herein, several variables may be manipulated to affect the physical properties such as texture, airiness, and consistency of the finished product. In some embodiments, the speed at which the ingredients are mixed can impact the texture of soft serve ice cream. For Example, a faster mixing speed can lead to a smoother, more homogenized mixture, while slower speeds might result in a chunkier, less uniform product. Mixing speeds can range from 100 to 400 RPM, depending on the specific equipment being used. The rate at which the mixture is frozen may affect the size of ice crystals and in turn the texture of the ice cream. Rapid freezing results in smaller ice crystals and a smoother texture, while slow freezing can produce larger ice crystals and a grainier product. Freezing rates can be adjusted based on temperature settings, which might range from −20° F. to −40° F. As mentioned before, overrun refers to the amount of air incorporated into the ice cream during the freezing process. The air incorporation rate can be manipulated by adjusting the speed of the dasher or pump responsible for adding air. Overrun percentages can range from 20% to 50%, where higher percentages lead to lighter, fluffier products and lower percentages yield denser, creamier outcomes.

The amount of time the mixture spends in the freezing cylinder before it is dispensed may result in a softer, less structured ice cream, while a longer dwell time can lead to a firmer product. Dwell times can vary from 5 to 15 minutes depending on the machine and desired consistency. In some soft serve machines, the pressure at which the product is extruded can be adjusted. Higher pressures will force the product out more quickly, potentially impacting its texture and the incorporation of air. The pressure may range from 10 psi to 50 psi depending on the design of the machine.

An aspect of the disclosure is directed to a production flow for soft serve or gelato. An example process flow may include the following steps. The process may with the receipt of ingredients which are then sorted into either dry storage or cold storage, based on their nature of the ingredients.

From storage, the ingredients may be measured and categorized into different types: dry ingredients, flavoring ingredients, milk, and cream. The dry ingredients and flavoring ingredients undergo a sanitation process to ensure cleanliness and safety. In some embodiments, milk may be emulsified or otherwise blended with the measured ingredients. In some embodiments, cream or a milk with higher fat content may be added to the mix to enrich texture and/or taste. This combined blend then goes through a series of steps to ensure its quality and consistency: pasteurization, to kill any harmful microorganisms; homogenization, to break down fat molecules and ensure a uniform mixture; and then transfer to an aging tank, which allows the mixture to mature and develop in flavor. Post aging, the mixture is sent to a continuous freezer which churns and freezes the gelato to its desired consistency. After freezing, the ice cream product is extracted for packaging. Finally, the packaged product is ready for distribution to various outlets or consumers.

Another aspect of the disclosure is directed to a simplified process of manufacturing, that may include control points, which are useful for quality and safety assurance. These control points are points in the production process where potential hazards or product features can be controlled or eliminated.

Starting with the purchasing of ingredients or raw materials, the ingredient are received and sorted into dry and cold storage based on their preservation requirements. After storage, these ingredients may be measured and prepared for an emulsification process. Pasteurization may be considered as CP #1 where the mixture is heated to 73° C. or above for at least 30 minutes. The accuracy of this process may be continuously monitored and recorded, with quarterly inspections by the Dairy Department.

Post-pasteurization, the mix undergoes homogenization and is then transferred to an aging tank. The transfer may be accomplished by flowing through a Homogenizer and a Heat Exchanger into the Aging Tanks. The aging tank, a CP #2, cools the pasteurized mix to a temperature between 4-5° C., ensuring the mix matures appropriately. The pasteurized Mix is cooled to 4° C. (39° F.), and then being kept between 4-5° C. (39-41° F.). The aging tanks may be equipped with an automatic turn on and off, to keep the product within the desired temperature range. The consistency and quality of the intermediary ingredients may be monitored at this stage to affect the quality of the final product.

After aging, the product is moved to a freezer, a CP #3. Here, the intermediary ingredients consistency and temperature may again be monitored closely through an internal thermometer. The product is extracted from the freezer when it reaches a temperature between −7° C. to −9° C., ensuring the right texture. In some embodiments, the ingredient quality and overall quality of the product is apparent. For example, if the product exits at a point in manufacturing and is too soft, then there is a problem, which may be addressed. However, in the majority of cases, when maintaining the above control points, the product has been observed to consistently come out at a specific consistency/texture.

Finally, after the freezing process, the product goes through extraction, CP #4, where it is stored at temperatures ranging between −20° C. and −25° C. in walk-in storage freezers. Product may be stored at −26° C. (−15° F.). Finished product temperature measures between −20° C. & −25° C. (−4° to −13° F.). Regular temperature checks may be made daily to ensure consistency and safety. To summarize, the manufacturing process is streamlined with checkpoints to ensure product quality and safety. Regular inspections, temperature checks, and verifications at control points are useful in order to further control the final product's integrity.

### EXAMPLES

The following examples are given for the purpose of illustrating various embodiments of the disclosure and are not meant to limit the present disclosure in any fashion. One skilled in the art will appreciate readily that the present disclosure is well adapted to carry out the objects and obtain the ends and advantages mentioned, as well as those objects, ends and advantages inherent herein. Changes therein and other uses which are encompassed within the spirit of the disclosure as defined by the scope of the claims will occur to those skilled in the art.

### Example 1

This example illustrates a general formulation of soft serve formulation of according to one embodiment of the disclosure, which includes corn syrup as well as other ingredients for a commercial soft serve cone. The soft serve cone will typically begin melting soon after being exposed to warm temperatures and is not well suited for distribution in a package, or storage for a later time.

| Ingredient | Quantity (g) | Weight Percentage |
|---|---|---|
| Whole Milk | 500 | 51.7% |
| Heavy Cream | 250 | 25.9% |
| Granulated Sugar | 150 | 15.5% |
| Corn Syrup | 50 | 5.2% |
| Stabilizer Blend* | 5 | 0.5% |
| Emulsifier Blend** | 2 | 0.2% |
| Flavoring*** | 10 | 1.0% |
| Total | 967 | |

*Stabilizer Blend (total weight): A combination of 1.5 g Guar Gum, 1 g Locust Bean Gum, and 2.5 g Carrageenan.
**Emulsifier Blend (total weight): A combination of 1 g Glyceryl Monostearate and 1 g Polysorbate 80.
***Flavoring may be to taste

### Example 2

This example illustrates a soft serve ice cream formulation of an embodiment of the disclosure with ten times less emulsifier.

| Ingredient | Weight Percentage (%) |
|---|---|
| Whole Milk | 50 |
| Heavy Cream | 22 |
| Granulated Sugar | 15 |
| Non-Fat Dry Milk | 3 |
| Stabilizer Blend | 0.02 |
| Emulsifier Blend | 0.02 |
| Flavoring (e.g., chocolate) | As per taste |

In this formulation, the percentage of emulsifier blend has been reduced to 0.02%, which is one-tenth of the amount used in the previous examples. The goal of this adjustment is to maintain the emulsification properties desired for the soft serve ice cream while minimizing the emulsifier's presence. The formulation still includes stabilizers to maintain the soft serve's texture and consistency. The other ingredients' percentages may be balanced accordingly.

### Example 3

This example illustrates a soft serve ice cream formulation of an embodiment of the disclosure with the stabilizer percentage from approximately 0.35% to 0.5%:

| Ingredient | Weight Percentage (%) |
|---|---|
| Whole Milk | 48 |
| Heavy Cream | 20 |
| Granulated Sugar | 14 |
| Non-Fat Dry Milk | 6 |
| Stabilizer Blend | 0.4 |
| Emulsifier Blend | 0.05 |
| Flavoring (e.g., vanilla) | As per taste |

In this formulation, the stabilizer blend is at 0.4%, which is within the desired range of around 0.35% to 0.5%. The stabilizer plays a role in maintaining the soft serve's texture and preventing ice crystal formation during freezing.

### Example 4

This example illustrates a chocolate soft serve ice cream of an embodiment of the disclosure suitable for a pouch.

| Ingredient | Weight Percentage (%) |
|---|---|
| Whole Milk | 55.9 |
| Heavy Cream | 23.2 |
| Granulated Sugar | 16.0 |
| Non-Fat Dry Milk | 3.0 |
| Cocoa Powder | 1.8 |
| Stabilizer Blend | 0.35 |
| Emulsifier Blend | 0.05 |

### Example 5

This example illustrates a chocolate soft serve ice cream of an embodiment of the disclosure suitable for a pouch.

| Ingredient | Weight Percentage (%) |
|---|---|
| Whole Milk | 55.5 |
| Heavy Cream | 23.0 |
| Granulated Sugar | 15.8 |
| Non-Fat Dry Milk | 2.9 |
| Cocoa Powder | 1.7 |
| Stabilizer Blend | 0.35 |
| Emulsifier Blend | 0.05 |

Note, the quantities provided in the table are for illustrative purposes only and may not represent the exact ratios used in commercial soft serve production. The specific ingredient amounts and proportions may vary based on the manufacturer's recipe and desired characteristics of the soft serve.

### Example 6

This example illustrates a soft serve ice cream formulation of an embodiments of the disclosure that was tested with different weight percentages of certain ingredients. The formulation provided an adequate soft serve ice cream, but did not yield suitable soft serve properties according to this disclosure, leading to suboptimal results. The formulation's challenges primarily revolved around issues with texture, taste, melting rate, and consistency.

| Ingredient | Weight Percentage (%) |
|---|---|
| Whole Milk | 50% |
| Heavy Cream | 20% |
| Granulated Sugar | 20% |
| Non-Fat Dry Milk | 7% |
| Cocoa Powder | 0.5% |
| Stabilizer Blend | 0.2% |
| Emulsifier Blend | 2.0% |

One ingredient that may affect the texture of soft serve is insufficient fat content. The formulation contained lower percentages of heavy cream and/or whole milk, resulting in a thinner and less creamy soft serve consistency. As a consequence, the soft serve lacked the desired smooth mouthfeel that are characteristic of high-quality soft serve ice cream. Additionally, the chosen stabilizer and emulsifier percentages were inadequate to effectively stabilize the mixture. As a result, the soft serve ice cream exhibited poor resistance to melting and had the potential for forming ice crystals during transportation/long term storage, detracting from the overall sensory experience. Finally, the formulation's sweetener content was not adequately balanced, resulting in either overly sweet or bland-tasting soft serve, depending on the specific ratios used. Achieving a balance of sweetness is relevant in producing a well-rounded and enjoyable soft serve ice cream. Relatedly, there were some challenges with flavor development, as insufficient flavoring or an imbalance in flavor components after transportation or heat shock sometimes led to a less pronounced taste profile.

MILK COMPONENTS

| | | |
|---|---|---|
| Milk Fat | 9.81 | g |
| Total Fat | 10.35 | g |
| Milk Solids | 15.41 | g |
| MSNF | 5.62 | g |
| Whey Solids | | g |
| Lactose | 3.01 | g |
| Total Solids | 36.46 | g |

### Example 7

This example illustrates a soft serve ice cream formulation of an embodiment of the disclosure that includes only seven ingredients, which offers several advantages that appeal to both consumers and manufacturers. In some embodiments, a soft serve formulation may consist or consist essentially of the following seven ingredients. In some embodiments, a blend of stabilizers or blend of emulsifiers may be used and still consist of the seven ingredients.

Chocolate Example

| | | |
|---|---|---|
| Whole Milk | 2225 grams | 55.88% |
| Heavy Cream | 931 | 23.38% |
| Sugar | 622 | 15.62% |
| Non Fat Dry Milk | 117 | 2.94% |
| Cocoa Powder | 71 | 1.78% |
| Stabilizer | 14 | 0.35% |
| Sunflower Lecithin | 2 | 0.05% |
| Total | 3982 g | |

### Example 8

This example illustrates a soft serve ice cream formulation of an embodiment of the disclosure that includes only seven ingredients, but with vanilla instead of chocolate. Note that the various amounts of the milk products and sweetener has been altered to achieve and/or conserve the desired properties.

Vanilla Example

| | | |
|---|---|---|
| Whole Milk | 2270 grams | 56.82% |
| Heavy Cream | 950 | 23.78% |
| Sugar | 635 | 15.89% |
| Non Fat Dry Milk | 119 | 2.98% |
| Stabilizer | 14 | 0.35% |
| Flavor 635 | 5 | 0.13% |
| Sunflower Lecithin | 2 | 0.05% |
| Total | 3995 g | |

In summary, a soft serve ice cream formulation with only seven ingredients offers numerous advantages, including clean labeling, allergen-friendliness, enhanced flavors, improved texture, and streamlined production processes. The simplicity and transparency of the formulation contribute to a positive consumer experience.

### Definitions

The section headings used herein are for organizational purposes only and are not to be construed as limiting the subject matter described.

It is noted that, as used in this specification and the appended claims, the singular forms “a”, “an” and “the” include plural referents unless expressly and unequivocally limited to one referent. It will be apparent to those skilled in the art that various modifications and variations can be made to various embodiments described herein without departing from the spirit or scope of the present teachings. Thus, it is intended that the various embodiments described herein cover other modifications and variations within the scope of the appended claims and their equivalents.

Unless defined otherwise, all technical and scientific terms used herein have the same meaning as is commonly understood by one of ordinary skill in the art. The use of the term “including” as well as other forms, such as “include”, “includes,” and “included,” is not limiting. The use of the term “having” as well as other forms, such as “have”, “has,” and “had,” is not limiting. As used in this specification, whether in a transitional phrase or in the body of the claim, the terms “comprise(s)” and “comprising” are to be interpreted as having an open-ended meaning. That is, the above terms are to be interpreted synonymously with the phrases “having at least” or “including at least.” For example, when used in the context of a process, the term “comprising” means that the process includes at least the recited steps but may include additional steps. When used in the context of a compound, composition, or device, the term “comprising” means that the compound, composition, or device includes at least the recited features or components, but may also include additional features or components.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

The terms “SoftServe,” “SoftServe ice cream,” “softserve formulation,” and “ice cream” as used herein, may be used interchangeably to refer to a frozen dessert or the ingredients thereof. In certain instances, where apparent from the context, softserve ice cream may refer to a specific type of ice cream.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

What is claimed is:

1. An ice cream formulation, comprising:
whole milk ranging from 45% to 60% by weight of the total formulation;
heavy cream ranging from 20% to 30% by weight of the total formulation;
non-fat dry milk ranging from 2% to 5% by weight of the total formulation;
one or more sweeteners ranging from 15% to 20% by weight of the total formulation;
one or more stabilizers ranging from 0.1% to 0.5% by weight of the total formulation;
one or more emulsifiers ranging from 0.1% to 0.5% by weight of the total formulation; and
one or more flavoring agents ranging from 0.1% to 2% by weight of the total formulation.

2. The ice cream formulation of claim 1, wherein the formulation is a soft serve formulation, and the soft serve formulation has an air overrun of 20% to 100%.

3. The ice cream formulation of claim 2, wherein the soft serve formulation has a viscosity between approximately 1600 to 1800 cP at about −5° C.

4. The ice cream formulation of claim 2, wherein the soft serve formulation consists essentially of whole milk ranging from 45% to 60% by weight of the total formulation;
heavy cream ranging from 20% to 30% by weight of the total formulation;
non-fat dry milk ranging from 2% to 5% by weight of the total formulation;
sweetener ranging from 15% to 20% by weight of the total formulation,
stabilizer ranging from 0.1% to 0.5% by weight of the total formulation;
emulsifier ranging from 0.1% to 0.5% by weight of the total formulation; and
flavor ranging from 0.1% to 2% by weight of the total formulation.

5. The ice cream formulation of claim 1, wherein the formulation displays at least one of the following properties:
the formulation is solid at 0 degrees Celsius and partial melting begins later than at least 5 minutes at 25 degrees Celsius;
the formulation maintains a consistency of SoftServe for at least 30 minutes when transported in a cooler;
the formulation maintains a consistency of SoftServe when refrozen after being exposed to room temperature for at least 10 minutes;
the formulation maintains a consistency of SoftServe at 0° C. for at least one month; and
the formulation maintains a consistency of SoftServe at 20° C. for at least 15 minutes.

6. The ice cream formulation of claim 1, wherein the formulation is packaged in a pouch.

7. The ice cream formulation of claim 6, wherein the formulation is solid at 0 degrees Celsius and begins to have liquid flow after 5 minutes at 25 degrees Celsius.

8. The ice cream formulation of claim 6, wherein the pouch is a plastic pouch with a screw on a distal end of the plastic pouch, and the thickness of the pouch is between 50 μm and 150 μm.

9. The ice cream formulation of claim 6, wherein the formulation remains frozen for at least 30 minutes while in contact with an ice bath.

10. The ice cream formulation of claim 1, wherein the whole milk ranges from 54% to 57% by weight, the heavy cream ranges from 22% to 24% by weight, the sweetener ranges from 15% to 16% by weight, the non-fat dry milk ranges from 2% to 4% by weight, the stabilizer ranges from 0.3% to 0.4% by weight, and the emulsifier ranges from 0.02% to 0.07% by weight.

11. The ice cream formulation of claim 1, wherein the stabilizer is a blend of Guar Gum, Vegetable Fiber, Tara Gum.

12. The ice cream formulation of claim 1, wherein the emulsifier is Sunflower Lecithin.

13. A method of making an ice cream from the ice cream formulation of claim 1, the method comprising:
mixing one or more ingredients to create a mixture, wherein the one or more ingredients are selected from whole milk, heavy cream, non-fat dry milk, sweetener, stabilizer, emulsifier and flavor;
emulsifying the mixture;
pasteurizing the mixture;
homogenizing the mixture;
aging the mixture;
freezing the mixture; and
extracting the mixture.

14. The method of claim 13, wherein pasteurizing the mixture occurs at 73 degrees Celsius or above for a minimum of 30 minutes.

15. The method of claim 14, wherein a pasteurized mixture is cooled to between 4 degrees Celsius and 5 degrees Celsius and is aged for at least 4 hours.

16. The method of claim 14, wherein a frozen mixture is extracted at a temperature between −7 degrees Celsius and −9 degrees Celsius, and the mixture is stirred at a stir speed between 100 and 1000 RPM.

17. The method of claim 14, wherein the extracted mixture has a viscosity between 15,000 to 20,000 cP at about 5° C.

18. The method of claim 14, wherein the formulation is a soft serve ice cream, and the soft serve ice cream has an air overrun of 20% to 100%.

19. The method of claim 13, wherein the formulation is a soft serve ice cream, and the soft serve ice cream has an average size of ice crystals that is smaller than 50 micrometers, as measured by microscopy or differential scanning calorimetry.

20. The method of claim 13, wherein the formulation is a soft serve ice cream, and displays at least one of the following properties:
the formulation is solid at 0 degrees Celsius and partial melting begins later than at least 5 minutes at 25 degrees Celsius;
the formulation maintains a consistency of SoftServe for at least 30 minutes when transported in a cooler;
the formulation maintains a consistency of SoftServe when refrozen after being exposed to room temperature for at least 10 minutes;
the formulation maintains a consistency of SoftServe at 0° C. for at least one month;
the formulation maintains a consistency of SoftServe at 20° C. for at least 15 minutes;
the formulation is resilient to melting; and
the formulation is solid at 0 degrees Celsius and begins to have liquid flow after 5 minutes at 25 degrees Celsius.
